(19) United States
(12) Patent Application Publication
(10) Pub. No.: US 2014/0363737 A1
(43) Pub. Date: Dec. 11, 2014

(54) LITHIUM ION SECONDARY BATTERY

(71) Applicant: Hitachi, Ltd., Tokyo (JP)

(72) Inventor: Kazushige Kohno, Tokyo (JP)

(73) Assignee: Hitachi, Ltd., Tokyo (JP)

(21) Appl. No.: 14/363,628

(22) PCT Filed: Dec. 5, 2012
(86) PCT No.: PCT/JP2012/081440

§ 371 Date: Jun. 6, 2014

(30) Foreign Application Priority Data
Dec. 9, 2011 (JP) 2011-269521

(51) Int. Cl. H01M 4/131; H01M 4/525; C01G 49/00; H01M 4/52

(52) U.S. Cl. CPC H01M 4/131; H01M 4/523; H01M 4/525; C01G 49/0027; C01P 2002/74
USPC 429/221; 252/182.1

(57) ABSTRACT

A lithium ion secondary battery in which a high capacity, as well as a high level of safety, is achieved, by using an oxide material containing Li and Fe for a negative electrode active material. In the lithium ion secondary battery, the negative electrode active material is a mixed phase of LiFeO2 and LiFe5O8 and a material in which the value calculated as the ratio of the height of a diffraction peak belonging to LiFeO2 (200) plane and the height of a diffraction peak belonging to LiFe5O8 (311) plane, which are obtained by X-ray diffraction method, is 0.18 to 20.4.

### TECHNICAL FIELD

This invention relates to a lithium ion secondary battery which is excellent in the energy density characteristics.

### BACKGROUND ART

As a power source for an electronic device, a lithium ion secondary battery is expected to serve as a secondary battery in which downsizing and weight saving are expected. As a negative electrode active material of such a lithium ion secondary battery, a carbon material such as graphite (artificial graphite and natural graphite) and amorphous carbon and an alloy material containing silicon, tin or the like as the main component have been studied and practically used.

In recent years, however, as the demand for increasing the energy density of a battery increases in order to apply a battery to a large product such as an electric vehicle, technical development of a material with a high capacity per unit weight has been required. Further, with the increase in the energy density of a battery, it is required to enhance safety at the same time.

While a lithium ion secondary battery is charged, the potential relative to Li metal becomes around 0 V with the conventional materials described above (the carbon material and the alloy material), and thus there has been a risk that an Li metal dendrite generates if the battery is deteriorated or overcharged. Accordingly, lithium titanate, in which the potential during charging is more than 1 V and a dendrite of Li metal does not generate, has attracted attention as a new negative electrode material.

PTL 1 discloses a technique using a negative electrode material in which the potential relative to Li metal is 1 V or more in order to reduce the risk of the generation of an Li metal dendrite during the charge-discharge cycles. Further, it is suggested that the negative electrode material used is an oxide of lithium titanate such as Li₄₊ₓTi₅O₁₂ (x=−1 to 3) having a spinel structure and Li_{2+y}Ti₃O₇ (y=−1 to 3) having a ramsdellite structure. PTL 2 discloses a technique regarding a discharge capacity exceeding the theoretical capacity of graphite, 372 mAh/g, by using a mixture of NaFeO₂ and graphite as the negative electrode material. It is suggested that the insertion and removal of Li are easy because NaFeO₂ has a layered rock salt structure like LiCoO₂ and the like, which are known positive electrode materials. Further, PTL 3 discloses a technique in which about 40 cycles of charging and discharging become possible by using LiN(CF₃SO₂)₂ as an Li salt with LiFe₅O₈ which has been prepared by mixing compounds such as FeOOH and LiOH in an Li/Fe molar ratio of 10/1 to 10/7 and sintering the mixture.

### Citation List

### Patent Literature

PTL 1: JP-A-2010-153258
PTL 2: JP-A-2010-218834
PTL 3: JP-A-11-025977

### SUMMARY OF INVENTION

### Technical Problem

However, in addition to a high level of safety, an increase in the capacity is required at the same time for a negative electrode active material used for a lithium ion secondary battery for an electric vehicle. In addition, because Na has a larger molecular weight than Li, there is a possibility that it is unfavorable for increasing the capacity per weight. Furthermore, LiPF₆ and LiBF₄ have been generally used as Li salts of the electrolyte in the conventional Li ion batteries, and it is desirable that a negative electrode material can be charged and discharged even when LiPF₆ is used instead of LiN(CF₃SO₂)₂, in view of the availability as a product or the like.

An object of this invention is to provide a lithium ion secondary battery in which the initial charge-discharge efficiency is improved and a high capacity is achieved by using an oxide material containing Li and Fe as a negative electrode active material.

### Solution to Problem

This invention is characterized in that, in a lithium ion secondary battery containing a positive electrode and a negative electrode facing each other through a separator, negative electrode active material is a mixed phase of LiFeO₂ and LiFe₅O₈ and comprises a material in which the value calculated as the ratio of the height of a peak belonging to LiFeO₂ (200) plane and the height of a peak belonging to LiFe₅O₈ (311) plane, which are obtained by X-ray diffraction method, is 0.18 to 20.4.

### Advantageous Effects

In this invention, a mixture of oxide materials containing Li and Fe in which the main components of the oxides are represented by LiFeO₂ or LiFe₅O₈ is used as the negative electrode active material, and thus it is possible to provide a lithium ion secondary battery in which the initial charge-discharge efficiency of the negative electrode material is increased to more than 77% and a high level of safety and an increased capacity are both ensured.

### BRIEF DESCRIPTION OF DRAWINGS

FIG. 1 shows a schematic cross-sectional view of a model battery to which this invention is applied.

FIG. 2 shows results of X-ray diffraction regarding Example 3.

FIG. 3 shows results of X-ray diffraction regarding Comparative Example 1.

### DESCRIPTION OF EMBODIMENTS

### (Production of LiFeO₂ and LiFe₅O₈ Oxides)

The mixture of LiFeO₂ and LiFe₅O₈ oxides was produced by the following procedure. Lithium hydroxide monohydrate (manufactured by Wako Pure Chemical Industries, Ltd.) was used as the Li raw material and iron oxyhydroxide (manufactured by Kojundo Chemical Laboratory Co., Ltd.) or iron (III) oxide (Fe₂O₃) was used as the Fe raw material. First, the raw material compounds were mixed in a certain Li and Fe molar ratio and put into a sealed-type sample reactor (manufactured by SAN-AI Kagaku Co. Ltd.) with distilled water (manufactured by Wako Pure Chemical Industries, Ltd.). Then, the reactor was placed in an electric furnace and kept at 200° C. for a certain time to conduct hydrothermal reaction. The material treated was washed with distilled water for several times, separated from the solution by filtration and dried at 80° C. for five hours to produce the oxide mixture.

The synthesis condition of the material regarding this invention described above is an example and the condition is not limited by the numerical values described. For example, the sample may be dried after the filtration under a reduced pressure condition using a vacuum dryer or the like.

### (Identification of Crystal Phase)

The crystal state of the sample prepared was identified using a wide-angle X-ray diffraction apparatus (manufactured by Rigaku Corporation, RU200B). The measurement condition for identifying the crystals is as follows.

The X-ray source was Cu and the output power thereof was set to be 50 kV and 150 mA. A concentration-method optical system with a monochromator was used, and a divergence slit of 1.0 deg, a receiving slit of 0.3 mm and a scattering slit of 1.0 deg were selected. The scan axis of X-ray diffraction was 2θ/θ interlock system and the measurement was conducted in the range of 30≦2θ≦50 deg by continuous scanning under the condition of a scanning speed of 2.0 deg/min and sampling of 0.02 deg.

Regarding the crystal identification, the crystals precipitated in the material were identified using ICDD data, which is an X-ray diffraction standard data set.

Examples of this invention, are shown below.

### Example 1

Lithium hydroxide monohydrate (manufactured by Wako Pure Chemical Industries, Ltd.) was used as the Li raw material and α-iron oxyhydroxide (manufactured by Kojundo Chemical Laboratory Co., Ltd.) was used as the Fe raw material. First, the raw material compounds were mixed in an Li and Fe molar ratio of 3.0/1 and put into a sealed-type sample reactor (manufactured by SAN-AI Kagaku Co. Ltd.) with distilled water (manufactured by Wako Pure Chemical Industries, Ltd.). Then, the reactor was placed in an electric furnace and kept at 200° C. for 20 hours to conduct hydrothermal reaction. The material treated was washed with distilled water for several times, separated from the solution by filtration and dried at 80° C. for five hours and the material obtained was subjected to X-ray diffraction measurement. As a result of identification of the crystals precipitated in the material using TCDD data, which is an X-ray diffraction standard data set, it was confirmed that LiFeO₂ and LiFe₅O₈ were contained.

### Example 2

Lithium hydroxide monohydrate (manufactured by Wako Pure Chemical Industries, Ltd.) was used as the Li raw material and γ-iron (III) oxide “γ-Fe₂O₃” (manufactured by Kojundo Chemical Laboratory Co., Ltd.) was used as, the Fe raw material. First, the raw material compounds were mixed in an Li and Fe molar ratio of 1.5/1 and put into a sealed-type sample reactor (manufactured by SAN-AI Kagaku Co. Ltd.) with distilled water (manufactured by Wako Pure Chemical Industries, Ltd.). Then, the reactor was placed in an electric furnace and kept at 200° C. for 20 hours to conduct hydrothermal reaction. The material treated was washed with distilled, water for several times, separated from the solution by filtration and dried at 80° C. for five hours. As a result of X-ray diffraction of the material prepared and identification of the crystals precipitated in the material using ICDD data, which is a standard data set, it was confirmed that LiFeO₂ and LiFe₅O₈ were contained.

### Example 3

Hydrothermal synthesis was conducted in accordance with Example 2 except that the raw material compounds were mixed in an Li and Fe molar ratio of 2.5/1. As a result of X-ray diffraction of the material prepared and identification of the crystals precipitated in the material using ICDD data, which is a standard data set, it was confirmed that LiFeO₂ and LiFe₅O₈ were contained.

### Example 4

Hydrothermal synthesis was conducted in accordance with Example 1 except that γ-iron oxyhydroxide (manufactured by Kojundo Chemical Laboratory Co., Ltd.) was used as the Fe raw material. As a result of X-ray diffraction of the material prepared and identification of the crystals precipitated in the material using ICDD data, which is a standard data set, was confirmed that LiFeO₂ and LiFe₅O₈ were contained.

### Example 5

Hydrothermal synthesis was conducted in accordance with Example 4 except that the raw material compounds were mixed in an Li and Fe molar ratio of 5.0/1. As a result of X-ray diffraction of the material prepared and identification of the crystals precipitated in the material using TCDD data, which is a standard data set, it was confirmed that LiFeO₂ and LiFe₅O₈ were contained.

### Example 6

Lithium hydroxide monohydrate (manufactured by Wako Pure Chemical Industries, Ltd.) was used as the Li raw material and γ-iron (III) oxide “γ-Fe₂O₃” (manufactured by Kojundo Chemical Laboratory Co., Ltd.) was used as the Fe raw material. First, the raw material compounds were mixed in an Li and Fe molar ratio of 3.0/1 and put into a sealed-type sample reactor (manufactured by SAN-AT Kagaku Co. Ltd.) with distilled water (manufactured by Wako Pure Chemical Industries, Ltd.). Then, the reactor was placed in an electric furnace and kept at 200° C. for 10 hours to conduct hydrothermal reaction. The material treated was washed with distilled water for several times, separated from the solution by filtration and dried at 80° C. for five hours. As a result of X-ray diffraction of the material prepared and identification of the crystals precipitated in the material using ICDD data, which is a standard data set, it was confirmed that LiFeO₂ and LiFe₅O₈ were contained.

### Example 7

Hydrothermal synthesis was conducted in accordance with Example 6 except that γ-iron oxyhydroxide (manufactured by Kojundo Chemical Laboratory Co., Ltd.) was used as the Fe raw material. As a result of X-ray diffraction of the material prepared and identification of the crystals precipitated in the material using ICDD data, which is a standard data set, it was confirmed that LiFeO₂ and LiFe₅O₈ were contained.

### Example 8

Hydrothermal synthesis was conducted in accordance with Example 2 except that the raw material compounds were mixed in an Li and Fe molar ratio of 5.0/1. As a result of X-ray diffraction of the material prepared and identification of the crystals precipitated in the material using ICDD data, which is a standard data set, it was confirmed that LiFeO₂ and LiFe₅O₈ were contained.

### Example 9

Hydrothermal synthesis was conducted in accordance with Example 2 except that the raw material compounds were mixed in an Li and Fe molar ratio of 3.0/1. As a result of X-ray diffraction of the material prepared and identification of the crystals precipitated in the material using ICDD data, which is a standard data set, it was confirmed that LiFeO₂ and LiFe₅O₈ were contained.

### Example 10

Hydrothermal synthesis was conducted in accordance with Example 7 except that the raw material compounds were mixed in an Li and Fe molar ratio of 1.5/1. As a result of X-ray diffraction of the material prepared and identification of the crystals precipitated in the material using ICDD data, which is a standard data set, it was confirmed that LiFeO₂ and LiFe₅O₈ were contained.

### Example 11

Hydrothermal synthesis was conducted in accordance with Example 10 except that the raw material compounds were mixed in an Li and Fe molar ratio of 2.5/1. As a result of X-ray, diffraction of the material prepared and identification of the crystals precipitated in the material using ICDD data, which is a standard data set, it was confirmed that LiFeO₂ and LiFe₅O₈ were contained.

### Example 12

Hydrothermal synthesis was conducted in accordance with Example 8 except that the hydrothermal synthesis time was changed to five hours. As a result of X-ray diffraction of the material prepared and identification of the crystals precipitated in the material using ICDD data, which is a standard data set, it was confirmed that LiFeO₂ and LiFe₅O₈ were contained.

### Example 13

Hydrothermal synthesis was conducted in accordance with Example 8 except that the thermal synthesis time was changed to 10 hours. As a result of X-ray diffraction of the material prepared and identification of the crystals precipitated in the material using ICDD data, which is a standard data set, it was confirmed that LiFeO₂ and LiFe₅O₈ were contained.

### Example 14

Hydrothermal synthesis was conducted in accordance with Example 7 except that γ-iron oxyhydroxide (manufactured by Kojundo Chemical Laboratory Co., Ltd.) and γ-iron (III) oxide “γ-Fe₂O₃” (manufactured by Kojundo Chemical Laboratory Co., Ltd.) as the Fe raw materials were mixed in a molar ratio of 2/1 and this mixture was incorporated in an Li and Fe molar ratio of 3.0/1. As a result of X-ray diffraction of the material prepared and identification of the crystals precipitated in the material using ICDD data, which is a standard data set, it was confirmed that LiFeO₂ and LiFe₅O₈ were contained.

### Example 15

Hydrothermal synthesis was conducted in accordance with Example 7 except that γ-iron oxyhydroxide (manufactured by Kojundo Chemical Laboratory Co., Ltd.) and γ-iron (III) oxide “γ-Fe₂O₃” (manufactured by Kojundo Chemical Laboratory Co., Ltd.) as the Fe raw materials were mixed in a molar ratio of 2/1 and this mixture was incorporated in an Li and Fe molar ratio of 5.0/1. As a result of X-ray diffraction of the material prepared and identification of the crystals precipitated in the material using ICDD data, which is a standard data set, it was confirmed that LiFeO₂ and LiFe₅O₈ were contained.

### Comparative Example 1

Hydrothermal synthesis was conducted in accordance with Example 13 except that the raw material compounds were mixed in an Li and Fe molar ratio of 1/1. As a result of X-ray diffraction of the material prepared and identification of the crystals precipitated in the material using ICDD data, which is a standard data set, it was confirmed that LiFeO₂ and LiFe₅O₈ were contained.

### Comparative Example 2

Hydrothermal synthesis was conducted in accordance with Example 8 except that the raw material compounds were mixed in an Li and Fe molar ratio of 0.75/1. As a result of X-ray diffraction of the material prepared and identification of the crystals precipitated in the material using ICDD data, which is a standard data set, it was confirmed that LiFeO₂ and LiFe₅O₈ were contained.

### Comparative Example 3

γ-Iron (III) oxide “γ-Fe₂O₃” (manufactured by Kojundo Chemical Laboratory Co., Ltd.) was directly used.

### Comparative Example 4

γ-Iron oxyhydroxide (manufactured by Kojundo Chemical Laboratory Co., Ltd.) was directly used.

### Comparative Example 5

LiFeO₂ which was prepared in accordance with PTL 1 (JP-A-2010-153258) was used as the negative electrode active material. Specifically, it was prepared by mixing lithium carbonate (manufactured by Kojundo Chemical Laboratory Co., Ltd.) and γ-iron (III) oxide “γ-Fe₂O₃” (manufactured by Kojundo Chemical Laboratory Co., Ltd.) in the same amount as a mol number, temporarily powder-compacting to obtain pellets and calcining at 900° C. for 12 hours.

The summary of the above conditions is shown in Table 1. Table 1 shows the kinds of the Fe raw material regarding this invention, the charged compositions and the synthesis conditions thereof.

TABLE 1

| | | Li/Fe | | |
|---|---|---|---|---|
| | Kind of Fe Raw | Charged | Synthetic | Treatment |
| | Material | Molar Ratio | Method | Time |
| Example 1 | αFeOOH | 3/1 | Hydrothermal | 20 h |
| | | | Synthesis | |
| Example 2 | γFe₂O₃ | 1.5/1 | Hydrothermal | 20 h |
| | | | Synthesis | |
| Example 3 | γFe₂O₃ | 2.5/1 | Hydrothermal | 20 h |
| | | | Synthesis | |
| Example 4 | γFeOOH | 3/1 | Hydrothermal | 20 h |
| | | | Synthesis | |
| Example 5 | γFeOOH | 5/1 | Hydrothermal | 20 h |
| | | | Synthesis | |
| Example 6 | γFe₂O₃ | 3/1 | Hydrothermal | 10 h |
| | | | Synthesis | |
| Example 7 | γFeOOH | 3/1 | Hydrothermal | 10 h |
| | | | Synthesis | |
| Example 8 | γFe₂O₃ | 5/1 | Hydrothermal | 20 h |
| | | | Synthesis | |
| Example 9 | γFe₂O₃ | 3/1 | Hydrothermal | 20 h |
| | | | Synthesis | |
| Example 10 | γFeOOH | 1.5/1 | Hydrothermal | 20 h |
| | | | Synthesis | |
| Example 11 | γFeOOH | 2.5/1 | Hydrothermal | 20 h |
| | | | Synthesis | |
| Example 12 | γFe₂O₃ | 5/1 | Hydrothermal | 5 h |
| | | | Synthesis | |
| Example 13 | γFe₂O₃ | 5/1 | Hydrothermal | 10 h |
| | | | Synthesis | |
| Example 14 | γFe₂O₃ + γFeOOH | 3/1 | Hydrothermal | 10 h |
| | | | Synthesis | |
| Example 15 | γFe₂O₃ + γFeOOH | 5/1 | Hydrothermal | 10 h |
| | | | Synthesis | |
| Comparative | γFe₂O₃ | 1/1 | Hydrothermal | 10 h |
| Example 1 | | | Synthesis | |
| Comparative | γFe₂O₃ | 0.75/1 | Hydrothermal | 20 h |
| Example 2 | | | Synthesis | |
| Comparative | γFe₂O₃ | Not Treated | Not Treated | Not Treated |
| Example 3 | | | | |
| Comparative | γFeOOH | Not Treated | Not Treated | Not Treated |
| Example 4 | | | | |
| Comparative | γFe₂O₃ | 1/1 | Calcination | 12 h (900° C.) |
| Example 5 | | | in Atmosphere | |

### (Peak Ratio Calculation)

The ratio of LiFeO₂ and LiFe₅O₈ was calculated as the ratio of diffraction peak heights obtained by the above XRD diffraction method.

The height of a peak belonging to LiFeO₂ (200) plane and the value of a peak belonging to LiFe₅O₈ (311) plane were used.

The test calculation of the peak ratio is shown by the Formula 1.

Peak Ratio=Peak Value of LiFeO₂ (002) Plane/Peak Value of LiFe₅O₈ (311) Plane (Formula 1)

The XRD pattern of the material shown in Example 3 is shown in FIG. 2. As a result of calculation by (Formula 1) based on this result, the peak ratio was 0.23.

The XRD pattern of the material shown in Comparative Example 1 is shown in FIG. 3. As a result of calculation by (Formula 1) based on this result, the peak ratio was 0.16.

The peak ratios of Examples 1 to 15 and Comparative Examples 1, 2 and 5 are shown in Table 2. Table 2 shows the comparative results of the peak ratios and the initial charge-discharge efficiencies regarding this invention.

TABLE 2

| | | Initial Efficiency |
|---|---|---|
| | XRD Peak Ratio | (%) |
| Example 1 | 20.40 | 80.1 |
| Example 2 | 0.18 | 77.0 |
| Example 3 | 0.23 | 77.6 |
| Example 4 | 0.74 | 83.3 |
| Example 5 | 8.47 | 83.9 |
| Example 6 | 1.01 | 82.2 |
| Example 7 | 1.04 | 82.0 |
| Example 8 | 1.50 | 83.6 |
| Example 9 | 0.25 | 78.9 |
| Example 10 | 0.29 | 78.7 |
| Example 11 | 0.47 | 78.9 |
| Example 12 | 1.54 | 80.8 |
| Example 13 | 2.20 | 82.8 |
| Example 14 | 0.79 | 79.6 |
| Example 15 | 1.67 | 80.3 |
| Comparative | 0.16 | 74.7 |
| Example 1 | | |
| Comparative | 0.03 | 72.5 |
| Example 2 | | |
| Comparative | — | 71.0 |
| Example 3 | | |
| Comparative | — | 75.5 |
| Example 4 | | |
| Comparative | 29.94 | 51.4 |
| Example 5 | | |

### (Evaluation of Charge-Discharge Efficiency)

Next, the charge-discharge evaluation of these negative electrode materials is explained.

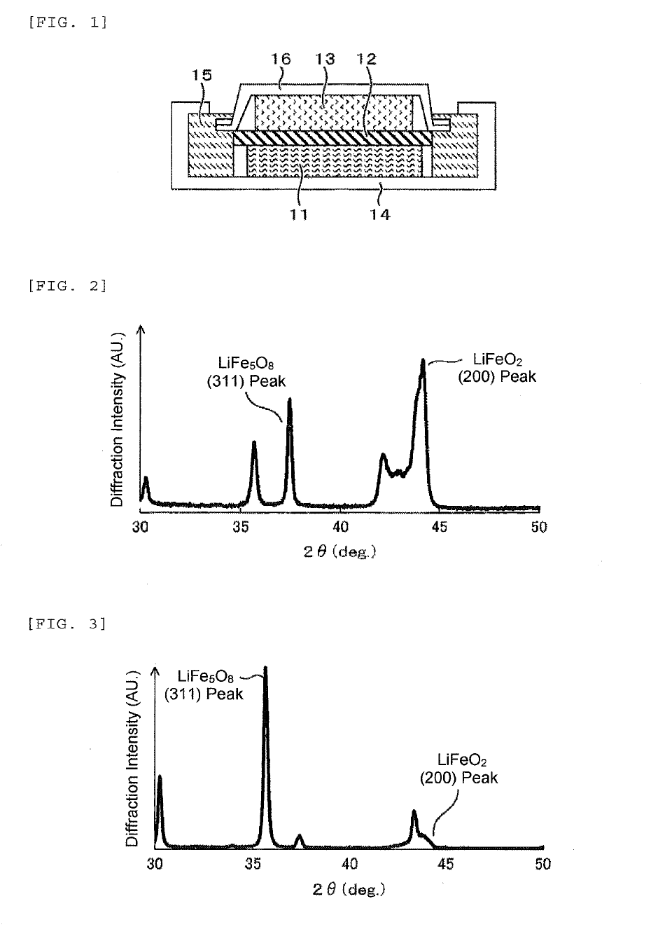

FIG. 1 is a schematic view showing an example of a model battery. Explanation below is made referring to this figure.

In this figure, a negative electrode layer containing a negative electrode active material and a conductive adjuvant is formed on the surface of a negative electrode current collector and they constitute a negative electrode 13. Further, for the evaluation this time, metal Li foil was used as a counter electrode 11.

Specifically, 80% by mass of a negative electrode powder (the negative electrode active material 2), 10% by mass of carbon black (the conductive adjuvant 3) and 10% by mass of a binder were mixed and normal methylpyrrolidon was added to produce a paste having a viscosity of 15 Pa·s (25° C.). The paste produced was coated on copper foil of the negative electrode current collector with a doctor blade and dried and thus the negative electrode layer was produced. The negative electrode 13 was produced by punching out the negative electrode layer and the negative electrode current collector together.

Then, as shown in FIG. 1, a separator 12 was inserted between the counter electrode 11 (metal Li foil was used this time) and the negative electrode 13 and they were placed in a battery case 14 of a coin battery. A gasket 15 was set and then a top cover 16 was provided. A coin-type cell was thus produced.

Here, a mixed solvent of ethylene carbonate (EC) and ethyl methyl carbonate (EMC) containing 1 mol of LiPF₆/(EC:EMC=1:2) was used as the electrolyte. Regarding the charge-discharge characteristics of the model battery, also using TSCAT 3000 (manufactured by Toyo system Co., Ltd.), the battery charge-discharge evaluation was conducted at a current density of 0.3 mA/cm² by charging and discharging within the range of 3.0 to 0.1 V (vs. Li/Li⁺) and the initial charge capacity (mAh/g) and discharge capacity (mAh/g) per weight of the active material contained in the electrode were measured. Further, the initial charge-discharge efficiency was calculated by the (Formula 2) shown below.

Initial Efficiency (%)=(Initial Discharge Capacity/Initial Charge Capacity)×100 (Formula 2)

The calculation results of the initial efficiencies of Examples 1 to 15 and Comparative Examples 1 to 5 are shown in Table 2.

As a result, it was confirmed that the initial charge-discharge efficiencies were as high as 77% or more with the materials having peak ratios of 0.18 to 20.4.

### INDUSTRIAL APPLICABILITY

The negative electrode active material obtained in this invention has a higher capacity per weight than the conventionally-used carbon material and prevents the generation of a dendrite due to the excellent charge potential. Thus, it is expected that the negative electrode active material is applied to a power source of a mobile object or a stationary power storage, which requires a large lithium ion secondary battery excellent in safety.

### REFERENCE SIGN LIST

11: Counter Electrode
12: Separator
13: Negative Electrode
14: Battery Case
15: Gasket
16: Top Cover

1. A lithium ion secondary battery comprising a positive electrode and a negative electrode facing each other through a separator, which is characterized in that a negative electrode active material is a mixed phase of LiFeO₂ and LiFe₅O₈ obtained by hydrothermal synthesis and comprises a material in which a value calculated as the ratio of the height of a diffraction peak belonging to LiFeO₂ (200) plane and the height of a diffraction peak belonging to LiFe₅O₈ (311) plane, which are obtained by X-ray diffraction method, is 0.18 to 20.4.

2. The lithium ion secondary battery of claim 1, which is characterized in that the negative electrode active material is a material showing a Coulomb efficiency of initial charging and discharging at 0.1 to 3 V of 77% or more.

3. The lithium ion secondary battery of claim 1, which is characterized in that the negative electrode active material is obtained by hydrothermal synthesis using Fe2O3 as a raw material.

4. A method for producing a negative electrode active material for a lithium ion secondary battery containing LiFeO2 and LiFe5O8, which is characterized by using Fe2O3 as a raw material and producing the negative electrode active material by hydrothermal synthesis.

5. The method for producing a negative electrode active material of claim 4, which is characterized in that the Li/Fe ratio of the raw material is 1.5 to 5.0.
